(19) United States
(12) Patent Application Publication
(10) Pub. No.: US 2017/0091097 A1
(43) Pub. Date: Mar. 30, 2017

(54) HAZARD CHECKING

(71) Applicant: ARM LIMITED, Cambridge (GB)

(72) Inventors: Alex James WAUGH, Cambridge (GB); Max John BATLEY, Cottenham (GB); Thomas Edward ROBERTS, Cambridge (GB)

(21) Appl. No.: 15/254,233

(22) Filed: Sep. 1, 2016

(30) Foreign Application Priority Data
Sep. 25, 2015 (GB) 1516967.5

(51) Int. Cl. G06F 12/0815; G06F 12/1027

(52) U.S. Cl. CPC G06F 12/0815; G06F 12/1027; G06F 2212/1008; G06F 2212/1016; G06F 2212/50; G06F 2212/682

(57) ABSTRACT

An apparatus comprises a translation lookaside buffer (TLB) comprising TLB entries for storing address translation data for translating virtual addresses to physical addresses. Hazard checking circuitry detects a hazard condition when two data access transactions correspond to the same physical address. The hazard checking circuitry includes a TLB entry identifier comparator to compare TLB entry identifiers identifying the TLB entries corresponding to the two data access transactions. The hazard condition is detected in dependence on whether the TLB entry identifiers match.

### BACKGROUND

Technical Field

The present technique relates to the field of data processing. More particularly, it relates to detecting a hazard condition when two data access transactions correspond to the same physical address.

Technical Background

When handling data access transactions for accessing data in a data store, such as load transactions for loading data from the data store or store transactions for storing data to the data store, it may be required to check whether two data access transactions correspond to the same physical address. This may be referred to as hazard checking. For example, hazard checking may be used to ensure that a series of data access transactions to the same location in the data store are handled in the correct order, or for improving performance by allowing successive store instructions to the same physical address to be merged.

### SUMMARY

At least some examples provide an apparatus comprising a translation lookaside buffer (TLB) comprising a plurality of TLB entries to store address translation data for translating a virtual address specified by a data access transaction to a physical address identifying a corresponding location in a data store; and

hazard checking circuitry to detect a hazard condition when two data access transactions correspond to the same physical address;

wherein the hazard checking circuitry comprises a TLB entry identifier comparator to compare TLB entry identifiers identifying the TLB entries corresponding to said two data access transactions; and

the hazard checking circuitry is configured to detect said hazard condition in dependence on whether the TLB entry identifier comparator detects that said TLB entry identifiers match.

At least some examples provide an apparatus comprising means for storing a plurality of entries to store address translation data for translating a virtual address specified by a data access transaction to a physical address identifying a corresponding location in a data store; and

means for detecting a hazard condition when two data access transactions correspond to the same physical address;

wherein the means for detecting comprises means for comparing entry identifiers identifying the entries corresponding to said two data access transactions; and

the means for detecting is configured to detect said hazard condition in dependence on whether the means for comparing detects that said entry identifiers match. At least some examples provide a data processing method comprising steps of:

translating a virtual address specified by a data access transaction to a physical address identifying a corresponding location in a data store using a translation lookaside buffer (TLB) comprising a plurality of TLB entries for storing address translation data; and

detecting a hazard condition when two data access transactions correspond to the same physical address;

wherein the detecting step comprises comparing TLB entry identifiers identifying the TLB entries corresponding to said two data access transactions, and detecting said hazard condition in dependence on whether said TLB entry identifiers match.

Further aspects, features and advantages of the present technique will be apparent from the following description of examples, which is to be read in conjunction with the accompanying drawings.

### BRIEF DESCRIPTION OF THE DRAWINGS

FIG. 1 schematically illustrates an example of a processing pipeline;

FIG. 2 shows an example of transaction queues for queueing pending data access transactions and hazard checking circuitry for detecting hazard conditions between two pending transactions;

FIG. 3 shows an example of the hazard checking circuitry;

FIG. 4 shows an example of a victim selection policy for a translation lookaside buffer (TLB) which prevents TLB entries corresponding to pending transactions being evicted;

FIG. 5 shows an example of alias detection for detecting when a new TLB entry to be allocated to the TLB corresponds to the same physical address has an existing entry;

FIG. 6 shows an example of circuitry for looking up whether a specified virtual address hits against an entry of the TLB;

FIG. 7 shows an example of alias detection circuitry supporting multiple page sizes;

FIG. 8 shows another example in which the transaction queues store an offset portion of the address of each transaction;

FIG. 9 shows a method of hazard detection; and

FIG. 10 shows an example of looking up a TLB and allocating entries.

### DESCRIPTION OF EXAMPLES

There may be a number of places within a data processing apparatus where different data access transactions undergo hazard checking for detecting whether two data access transactions correspond to the same physical address. For example, hazard checking circuitry could detect hazards between two pending load transactions for loading data from a given address in a data store. If the two loads correspond to the same physical address, then this may require certain ordering requirements to be satisfied to ensure correct results for example. Another example of hazard checking may be when two store transactions for storing data to a data store specify the same physical address, in which case the order in which the two stores are carried out may affect other instructions and even if the two stores are carried out in the correct order, it may be more efficient to replace the two stores with a single merged store operation which provides the same result as if the two stores were carried out in succession. Another example of hazard checking may be between a pending load and pending store operation to allow the value to be stored to the data store in response to the store operation to be forwarded to the load circuitry so that the load can be serviced before the store is carried out. Hence, there may be many reasons why it may be useful to detect hazard conditions when two data access transactions correspond to the same physical address.

Typically, hazard checking would be carried out by providing address comparators for comparing the physical addresses of respective data access transactions and triggering the hazard condition when the two transactions have the same physical address. However, the physical address may be relatively large (e.g. 44 bits), and so relatively large comparators may be required which can increase power consumption and make circuit timing requirements harder to meet. This problem scales with the number of different points of the system at which hazard checking is required, and with the number of pairs of transactions to be checked at each hazard checking point.

Many processing systems use virtual addressing where the data access transactions specify virtual addresses and the virtual addresses are translated into physical addresses identifying corresponding locations in a data store such as a cache or memory. Often a translation lookaside buffer (TLB) is provided to speed up address translation so that it is not necessary to access page tables in memory every time an address needs to be translated. The TLB has a number of TLB entries for storing address translation data for translating a virtual address within a corresponding page of the address space into a corresponding physical address.

Hazard checking circuitry can be provided with a TLB entry identifier comparator to compare TLB entry identifiers which identify the TLB entries corresponding to two data access transactions for which the hazard checking is to be performed. The hazard checking circuitry detects the hazard condition based on whether the TLB entry identifier comparator detects that the TLB entry identifiers match. The TLB entry identifiers are typically much smaller than the physical addresses and so by comparing TLB entry identifiers to detect hazards, this can avoid the need to compare the full physical addresses of the data access transactions, to make the hazarding comparators smaller and hence ease circuit timing and save power. This saving in power and area may be multiplied across the number of hazard detection points implemented in the system and so can be relatively significant.

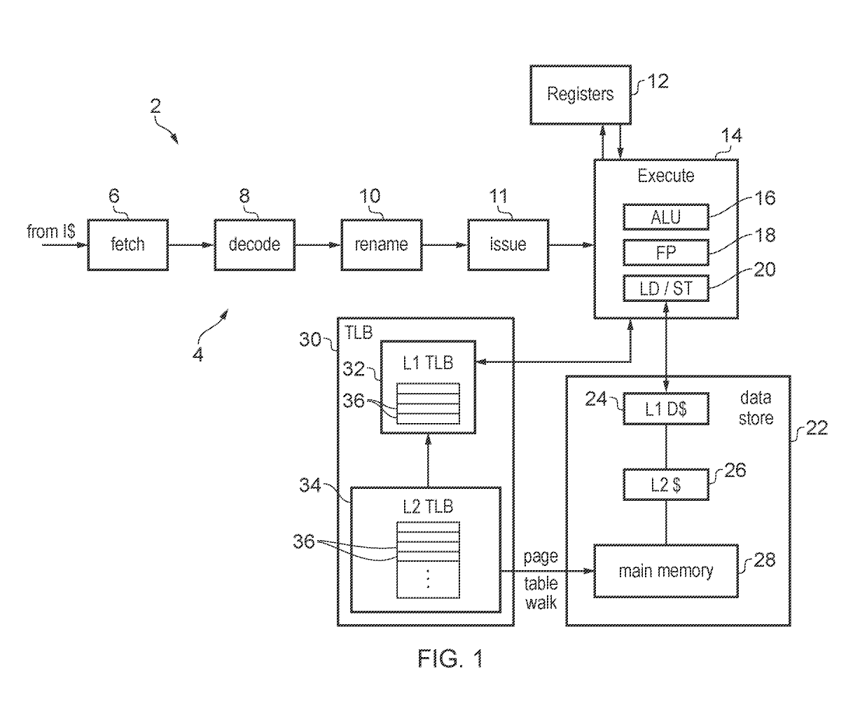

FIG. 1 schematically illustrates an example of a data processing apparatus 2 comprising a processing pipeline 4 for performing data processing. The pipeline 4 includes a number of stages including a fetch stage 6 for fetching instructions from an instruction cache, a decode stage 8 for decoding the fetched instructions, a register renaming stage 10 for performing register renaming to map architectural register specifiers specified by the instructions to physical register specifiers identifying registers within a physical set of registers 12, and issue stage 11 for determining when operands required by instructions are ready and issuing the instructions for execution when the operands are ready, and an execute stage 14 for executing the instructions to perform corresponding data processing operations. For example the execute stage 14 may include a number of execute units for executing different kinds of instructions, such as an arithmetic/logic unit (ALU) 16 for executing arithmetic instructions such as add or multiply instructions or logical instructions such as OR or AND instructions, a floating point unit 18 for executing floating-point instructions using data values represented in floating point format, and a load/store unit 20 for executing load operations for loading data values from a data store 22 and storing them in the registers 12, or store instructions for storing data from the registers 12 to the data store 22. It will be appreciated this is just one example of a possible pipeline architecture and different stages could be provided in other examples. For example, in an in-order processor the rename stage 10 may be omitted. Similarly, it will be appreciated that the execute units 16, 18, 20 are just one example and other examples may have different combinations of execute units for executing different kinds of instructions.

As shown in FIG. 1, the data store 22 may have a hierarchical structure including one or more caches 24, 26 and a main memory 28. The level 2 (L2) cache 26 caches a subset of data from the main memory for faster access. Similarly the level 1 (L1) data cache 24 caches a smaller subset of data from the memory 28 for each faster access than the L2 cache 26. Any known caching scheme may be used to control data transfer between the respective caches and memory. In general, references to the data store 22 herein may refer to any of the caches 24,26 and memory 28. Some embodiments may have greater or fewer levels of cache than the two levels shown in FIG. 1.

Load/store instructions executed by the pipeline 4 may identify the locations in the data store 22 to be accessed using virtual memory addresses. On the other hand the data store 22 itself may identify storage locations using a physical address. As shown in FIG. 1, a translation lookaside buffer (TLB) 30 is provided for speeding up address translations from virtual addresses to physical addresses. In this example, the TLB 30 includes two levels of translation lookaside buffers: a level 1 (L1) TLB 32 and a level 2 (L2) TLB 34. The L1 TLB 32 and L2 TLB 34 each include a number of TLB entries 36 for storing address translation for respective pages of the address space. Each entry corresponds to a corresponding page of the virtual address space and maps a virtual page address identifying that page to a corresponding physical page address in the physical address space used by the data store 22. TLB entries 36 may also specify other kinds of information such as data defining access permissions. For example the access permissions may define whether a particular process is allowed to read or write to the corresponding page of the address space. Typically the L2 TLB 34 may include a greater number of entries 36 than the L1 TLB, but the L1 TLB 32 may be faster to access. In response to a given load or store instruction specifying a virtual address, the virtual address is provided to the L1 TLB 32 and if the virtual address matches against one of the TLB entries 36 then the page address portion of the corresponding physical address is returned to the load/store unit 20 which triggers a request to the data store 22 using the physical address (an offset portion of the virtual address may be mapped unchanged to a corresponding portion of the physical address).

If the L1 TLB 32 does not contain the required entry then it sends a request to the L2 TLB which returns the entry for the required virtual page. The entry received from the L2 TLB 34 is allocated into one of the L1 TLB entries 36 and the L1 TLB 32 returns to the physical page address as before. On the other hand, if the L2 TLB 34 also does not include the required entry then the L2 TLB 34 can trigger a page table walk to request the required entry from page tables within main memory 28. Typically the page table walk is relatively slow and so by caching recently used TLB entries in the L1 or L2 TLBs 32 and 34, address translation can be made faster.

While FIG. 1 shows a TLB 30 with two levels of caching of page table entries, it will be appreciated that other numbers of levels could also be provided. For example, some examples may not have a L2 TLB 34, in which case the L1 TLB 32 could be the only TLB.

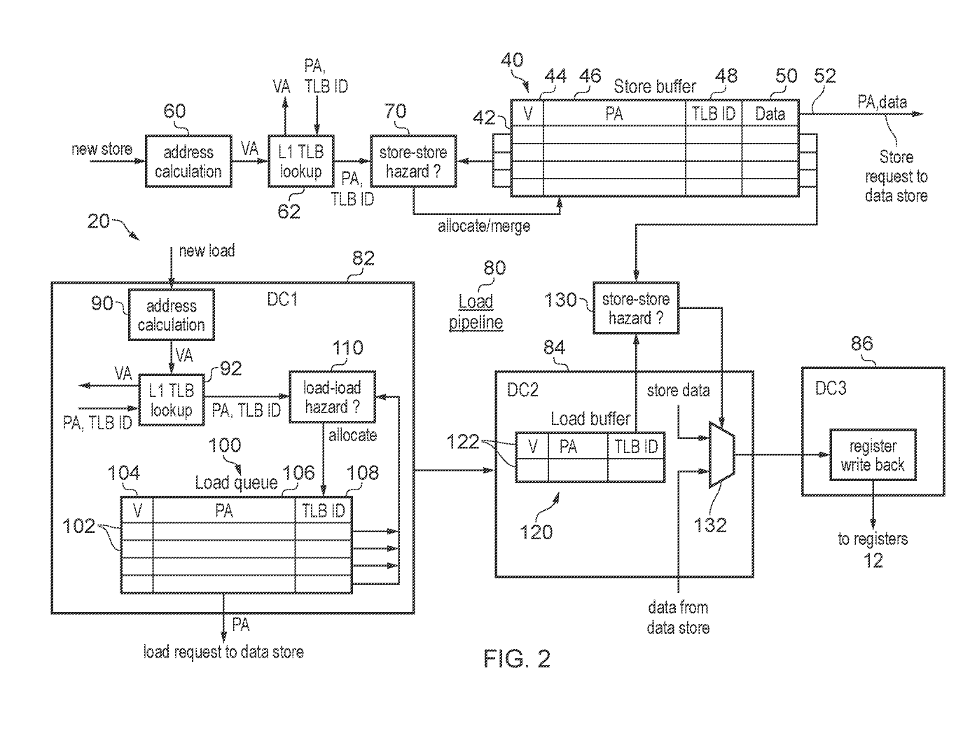

FIG. 2 shows in more detail an example of circuitry provided within the load store unit 20 for processing load or store transactions triggered by corresponding load or store instructions.

The load/store unit 20 includes a store buffer 40 including a number of store slots 42 for tracking pending store transactions. Each store slot 42 includes a valid bit 44 indicating whether the store transaction indicated in that slot is valid, a physical address 46 of the corresponding store transaction, a TLB identifier (TLB ID) 48 identifying the TLB entry 36 of the L1 TLB 32 corresponding to the store transaction, and some data 50 to be stored to the data store 22 in response to that store transaction. It will be appreciated that other information could also be stored for each store transaction. When bandwidth is available for carrying out a store to the data store 22 then a pending store transaction from the store buffer 48 is selected and a store request 52 for writing the store data 50 to the data store 22 is issued to the data store 22.

As shown in FIG. 2, when a new store transaction is received (in response to a store instruction executed at the execute stage 14) the new store is provided to an address calculating unit 60 which calculates the virtual address for the store. For example a store instruction may specify a base register in the register bank 12 and an offset value and the address calculation circuitry 60 may add the offset to a base address stored in the register 12. The offset could be specified as an immediate value by the store instruction or with reference to another register. In some addresses following the address calculation the address calculating circuitry 60 may update the base register based on the newly calculated virtual address, while in other cases the base register may be preserved so that a subsequent instruction referring to the same base register will use the same base address as the current instruction.

The address calculating unit 60 outputs the virtual address (VA) for the store to a TLB lookup circuit 62 which issues a request to the TLB 30 to look up a corresponding physical address (PA) for the specified virtual address. As well as an indication of the PA (or at least the page portion of the PA), the TLB 30 returns the TLB identifier (TLB ID) identifying which of the TLB entries 36 of the L1 TLB 32 matched the specified virtual address. If the L1 TLB 32 did not already store the required TLB entry then there may be some delay while the entry is fetched from the L2 TLB 34 or from main memory 38 before the physical address and TLB can be returned.

The returned physical address and TLB ID are provided to store-to-store hazard checking circuitry 70 for checking whether the new store transaction hazards against any of the existing store transactions in the store buffer 40. The store-to-store hazard checking circuitry 70 performs hazard checking between the new store transaction and any pending store transaction in a valid transaction slot 42 of the store buffer. For each valid pending transaction, the store-to-store hazard checking circuitry 70 detects a hazard if the TLB ID 48 in that transaction slot 42 matches the TLB ID returned by the TLB 30 for the new store transaction, and also an offset portion of the physical address 46 in the corresponding transaction slot 42 matches an offset portion of the physical address (PA) provided for the new store transaction. The offset portion is a portion of the physical address which is mapped directly from a corresponding portion of the virtual address (as opposed to a page address portion which is translated from a virtual page address portion by the TLB).

Typically the offset portion is relatively small (e.g. 12 bits for a 4 KB page size), while the page address portion of the physical address is relatively large (e.g. it may be of the order of 30 to 40 bits). On the other hand, the TLB ID may be relatively small. For example a typical TLB may have 32 entries and so the TLB ID may only have 5 bits. Therefore, by comparing the L1 TLB ID in place of the page address portion of the physical address, this can reduce the size of the comparators in the hazard checking circuitry 70 from around 40 bits to 17 bits for instance, which greatly reduces the overhead of the hazard checking circuitry 70.

When the store-to-store hazard checking circuitry 70 detects a hazard condition, then it may respond in various ways. In some systems a new store which hazards against an existing store may simply be allocated to the store buffer, but some ordering bits may be set for the respective hazarding stores to ensure that the hazarding stores are carried out in their original order so that after all the stores are finished then the data in the corresponding data store 22 will have the correct value. Other systems may improve performance by merging successive store transactions to the same address so that only one store request needs to be sent to the data store to write the same value to the data store which would result if two or more successive hazarding stores were performed one after the other. Hence, there may be different responses to detection of a hazard condition. If no hazard is detected then the new store may simply be allocated to an invalid entry of the store buffer 40.

FIG. 2 also shows a portion of a load pipeline 80 for handling pending load transactions performed in response to load instructions. In this example the load pipeline includes three pipeline stages 82, 84, 86. New load transactions are input to the first load pipeline stage 82 and again address calculating circuitry 90 is provided to calculate the virtual address for the load transaction. The virtual address may be calculated in a similar way to the address of the store transaction discussed above. The generated virtual address is provided to TLB lookup circuitry 92 which supplies the virtual address to the TLB 30 and receives in return the physical address translated from the virtual address and the TLB ID identifying which entry 36 of the L1 TLB 32 matched the virtual address.

The first load pipeline stage 82 includes a load queue 100 for queueing pending load transactions which are awaiting issuing of a load request to the data store. The load queue 100 includes a number of transaction slots 102 which identify pending loads. Each transaction slot 102 in this example includes a valid bit 104 identifying whether the corresponding slot contains a valid load transaction, the physical address 106 for that load and a TLB ID 108 of the matching TLB entry for the load.

The first load pipeline stage 82 includes load-to-load hazard detection circuitry 110 for detecting whether the incoming load corresponds to the same physical address as one of the existing loads pending in the load queue 100. Again, the load-to-load hazarding circuitry detects the hazard condition when the offset portions of the new and existing physical address match and also the TLB IDs for the new and existing loads match. This is done for each valid entry of the load queue 100 and if any hazard is raised then there are various actions which can be taken. For example, ordering information may be set to track the order in which successive loads to the same address are performed to ensure the correct results, or successive loads to the same address could be merged. Based on the hazard detection, the new load is allocated into an invalid entry of the load queue 100. When there is sufficient bandwidth for issuing a load request to the data store 22 then one of entries of the load queue 100 is selected and load request is triggered using the corresponding physical address.

When a load transaction is selected and a corresponding load request is issued to the data store, then that transaction passes to the second load pipeline stage 84 where the transaction is placed in a load buffer 120 which includes a number of slots 122 which again include a valid bit, the physical address and the TLB ID. The transactions remain in the load buffer 120 while awaiting return of the corresponding data from the data store. Store-to-load hazarding circuitry 130 is provided for detecting whether any hazard conditions occur between store transactions pending in the store buffer 40 and load transactions pending in the load buffer 120. Again, the hazards are detected by comparing the respective offset portions of the physical addresses and the TLB IDs of the respective store and load transactions in a similar way to the other hazard checking circuitry 70, 110 described above. If a hazard is detected then it is not necessary to wait for the data to be returned from the data store as the load can be serviced using the store data 50 from the store buffer 40 for the corresponding hazarding store. On the other hand, if no hazard is detected for a given load, the second load pipeline stage 84 awaits the return of the data from the data store. A multiplexer 132 for example selects between data from the store buffer 40 and the data from the data store 22 and outputs the appropriate data as the result of the load.

The third load pipeline stage 36 receives the data which is the result of the load and controls the data to be written back to one of the registers 12. It will be appreciated that FIG. 2 shows a particular example of a load/store pipeline 20 and other architectures can be used.

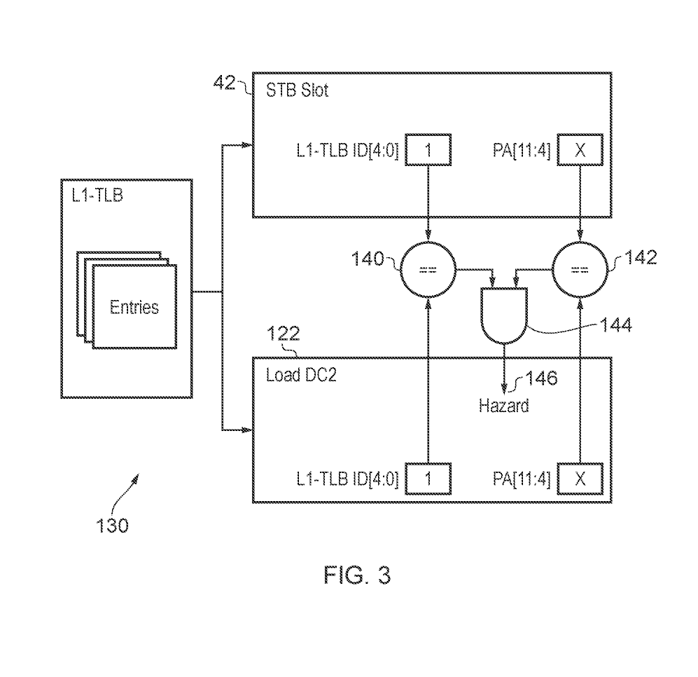

FIG. 3 shows an example of the store-to-load hazard checking circuitry 130 for detecting hazards between a store transaction in a transaction slot 42 of the store buffer 40 and a load transaction in transaction slot 122 of the load buffer 120. A shown in FIG. 3, the hazard checking circuitry 130 includes a TLB entry identifier comparator 140 for comparing the TLB IDs of the corresponding transactions in the store buffer slot 42 and the load buffer slot 122, and an offset comparator 142 for comparing the offset portions of the physical addresses in the corresponding slots 42, 122. In this example the offset portion of the addresses comprises bits [11:4] of the physical address, but in other systems using other page sizes, different sized address offsets can be compared. AND gate 144 receives the output of the two comparators 140, 142 and asserts a hazard signal 146 if both of the compactors 140, 142 do detect a match. If the hazard signal 146 is asserted then this indicates that there is a hazard condition since the transaction in the respective slots 42, 122 relate to the same physical address. On the other hand, if either the TLB IDs do not match or the offsets do not match, the transactions relate to different physical addresses and no hazard is signalled. When the hazard condition is detected, then the response may for example be that the store data is forwarded as the result of the load.

The other hazard checking circuitry 70, 110 may operate in a corresponding way to the hazard checking circuitry 130 shown in FIG. 3, with the only difference being the type of transactions being compared and the particular response taken when a hazard is detected.

While FIG. 3 shows a comparison between a particular pair of transactions, it will be appreciated that this may be repeated for each pair of corresponding transactions to be hazarded. For example, a bank of comparators 140, 142 may be provided with each set of comparators comparing the TLB IDs and offsets for a respective pair of transactions. Hence, by reducing the size of each comparator by using the TLB ID in place of the upper bits of the physical address, the overall size of the hazard checking logic can be greatly reduced.

As mentioned above, when a virtual address misses in the L1 TLB 32 then this may required a new entry to be fetched from the L2 TLB 34 or from page tables in memory. When the new TLB entry is received, it can be allocated to the L1 TLB 32, but if all the entries of the L1 TLB 32 already contain valid TLB entries then one of the existing entries may need to be invalidated. If a given entry of a TLB is invalidated before a corresponding load or store transaction specifying that entry with its TLB ID is complete, then this could lead to one of the hazard checking circuits 70, 110, 130 detecting a hazard due to matching TLB IDs between a new transaction and an existing transaction when in fact these transactions relate to the different addresses. To ensure that a pair of transactions with matching TLB IDs relate to the same physical page, the TLB 30 may prevent an entry being invalidated until there are no more outstanding transactions which corresponding to that entry which have not yet progressed beyond the last point at which hazards are detected using the TLB IDs. That is, the TLB may prevent invalidation or reallocation of a given TLB entry until any data access transaction specifying that entry using its TLB ID has progressed beyond the last stage of hazard checking. In FIG. 2, this could be when the transaction has progressed beyond the store buffer 40 or the load buffer 120.

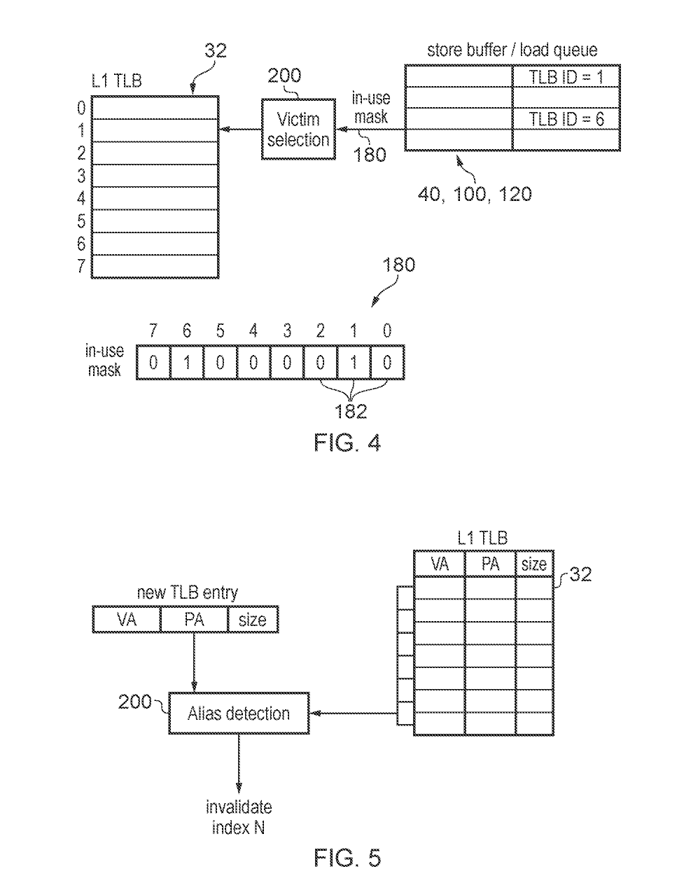

FIG. 4 shows one example of ensuring that TLB entries are locked in place to remain valid for as long as corresponding transactions are inflight, but it will be appreciated that other techniques could also be used. As shown in FIG. 4, each transaction queue for queueing transactions to be hazarded (e.g. the store buffer 40, the load queue 100 and the load buffer 120) may provide an in-use mask 180 to the TLB 30. As shown at the bottom of FIG. 4 the in-use mask 180 may comprise a series of bits 182, each corresponding to one of the transaction slots of the corresponding transaction queue 40, 100, 120. Each time a new transaction is allocated to the transaction queue 40, 100, 120, the queue asserts the bit 182 of the in-use mask which corresponds to the TLB entry specified by the TLB ID for that transaction. When a transaction leaves the queue, the queue clears the corresponding bit selected depending on the TLB ID of that transaction. Hence, the in-use mask 180 indicates the TLB which TLB entries need to be reserved.

A victim selection circuit 200 of the TLB 32 may prevent any in-use entries indicated by any of the in use masks 180 from the respective queues 40, 100, 120 being selected as victim entries to be invalidated and replaced with a new entry. Typically, the L1 TLB may include a greater number of entries than there are transaction slots in the respective queues 40, 100, 120, so a victim entry can always be allocated. The victim selection circuitry 200 may select the victim using any known algorithm, e.g. round robin or random, from among all the entries which are not indicated by any of the in-use masks 180 as currently being in use. This prevents translations with transactions in flight being victimised, and also as a side effect will result in a pseudo least recently used replacement policy without needing to use any additional hardware for tracking which entries are the least recently used.

Also, sometimes it may be required to flush the L1 TLB to invalidate all its entries. For example, when software (e.g. an operating system) updates the page tables in the main memory 28 it may trigger invalidation of all the TLBs 32, 34 to ensure that out of date translation data does not continue to be used. However, to allow the hazard checking circuitry to continue to validly compare TLB IDs, if the L1 TLB is flushed, any entries currently indicated as in use using the mask 180 may remain valid for a time so that they cannot be invalidated or victimised until the corresponding transactions in the transaction queue 40, 100, 120 are retired. Nevertheless, during this time no new transaction may hit against these entries. For example, each TLB entry may have corresponding state indicator indicating whether the entry is valid, invalid or in the state where the entry remains valid and cannot be victimised but no new transaction can hit against the entry.

Some architectures may allow aliasing of TLB entries where two different virtual addresses may be mapped to the same physical addresses. If aliasing is present, then two transactions to the same physical address could have different L1 TLB IDs and so this could potentially lead to hazard situations being missed. In systems compliant with an architecture that does not allow aliasing then this problem does not arise and so no alias detection circuitry is necessary.

However, if it is desirable to support an architecture which allows aliasing, then as shown in FIG. 5 alias detection circuitry 202 may be provided to detect when the physical address of a new TLB entry to be allocated to the TLB is the same as the physical address of an existing entry within the L1 TLB 32. When the alias condition is detected by the alias detection circuitry 202 then this can be handled in different ways. A simple approach can simply be to invalidate the existing the L1 TLB entry that corresponds to the same physical address as the new TLB entry. This ensures that there can only be one entry in the L1 TLB 32 for any given physical address, and so if any of the hazard checking circuits 70, 110, 130 detect different TLB IDs for a pair of transactions it is known that they relate to different physical addresses and so no hazard is detected. If the invalidated TLB entry relates to an in-flight transaction (e.g. that entry is indicated as “in-use” by the in-use mask as in FIG. 4), then the invalidation of this entry may wait until that transaction retires and so the later transaction which requires the new TLB entry to be allocated may also be delayed. Hence, it may take some cycles to deal with the aliasing issue. However, in practice aliasing is generally rare and so this penalty may not be encountered often.

In systems which support out-of-order processing, it is possible that when an alias occurs, a deadlock could arise when an older transaction requiring the new TLB entry to be allocated is waiting for an alias to be cleared by invalidating another entry, but the alias cannot clear until a younger transaction has completed, and the younger transaction cannot complete because it is dependent on the older transaction awaiting allocation of the new TLB entry. To address this issue, when an alias is detected between the new TLB entry and an existing TLB entry, the load/store unit 20 may detect whether there is at least one instruction which requires the existing TLB entry which is dependent on the instruction requiring the new TLB entry, and if so then that at least one instruction may be flushed from the pipeline and reissued later. In some cases the system may provide a more coarse grained flushing technique where for example all instructions which are younger than the instruction requiring the new TLB entry are flushed. In this way such deadlocks can be avoided. As aliasing may itself be rare, and even when aliasing occurs the deadlock condition may also be rare, then such deadlocks would be very rare and so the overhead of occasionally flushing more instructions than required may be justified given the simpler logic for triggering the flush if it is not necessary to identify the particular younger instruction that is dependent on the older instruction. Such deadlocks would not arise in an in-order processor, and so in this case the alias detection circuitry 202 may not need to trigger any flushing when aliasing is detected.

Another way of handling the aliasing may be to allow a certain number of TLB entries with aliased physical address to reside within the L1 TLB, but to keep a record of which L1 TLB identifiers correspond to the same physical address, and then the hazard checking circuitry 70, 110, 130 may have some additional logic to determine that a hazard condition is detected when two transactions specify a pair of different TLB IDs which have previously been identified as aliasing. However, in many cases aliasing may be sufficiently rare so that this extra logic may not be justified and it may be simpler just to invalidate an entry of the TLB when aliasing is detected.

In some cases, the TLB may support entries 36 corresponding to different page sizes. For example, each entry could correspond to a 4 KB page, 16 KB page, or 64 KB page with a size indicator identifying a page size for that entry. When looking up the TLB 30, and when detecting aliases as in FIG. 5, the page size may therefore need to be considered in order to determine which portions of the address should be compared.

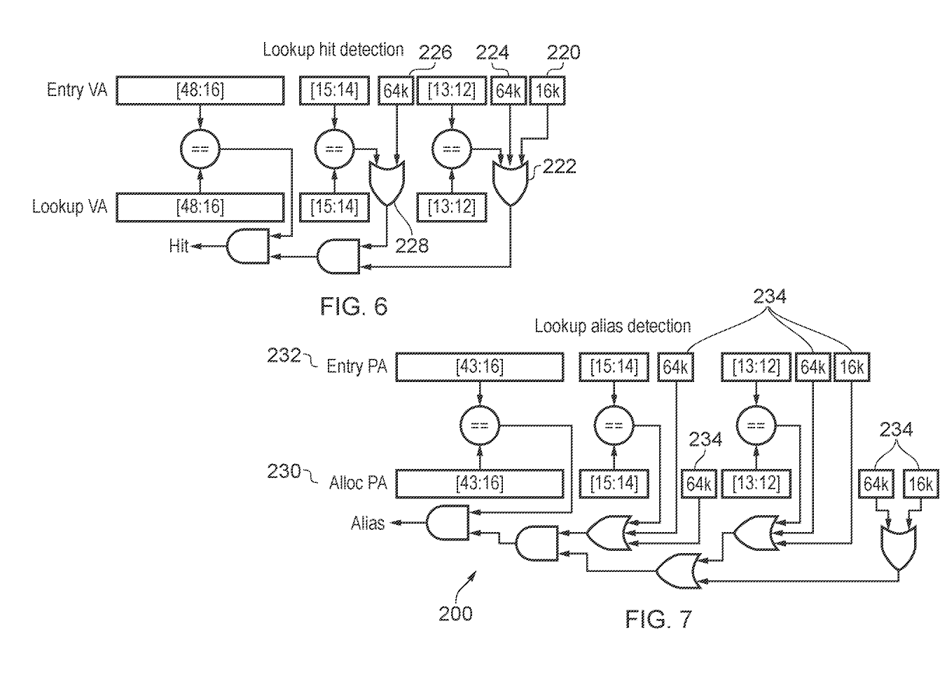

FIG. 6 shows an example of the circuitry for looking up the TLB for a new store or load. The upper portion of FIG. 6 shows bits [48:12] of a virtual address of an existing entry in the TLB and the lower portion shows the corresponding bits [48:12] of a virtual address to be compared against each entry to determine whether its hits in the TLB (in this example bits [11:0] of the address would be the offset portion which is mapped unchanged between the virtual and physical addresses). The comparison shown in FIG. 6 may be repeated for each TLB entry 36 of the L1 TLB 32. Bits [48:16] of the corresponding addresses are compared and affect the outcome of whether or not a hit is detected, regardless of whether the page size is 4, 16 or 64 KB. When the page size is 4 KB, then bits [15:14] and [13:12] of the addresses are also compared and a network of OR and AND gates ensures the hit signal is only generated if all of the bits [48:12] of the stored virtual address in the TLB match the corresponding bits of the looked up virtual address. When the page size is 16 KB, then a flag 220 is set to 1 and provided to OR gate 222 so that the output of OR gate 222 is always 1 regardless of whether bits [13:12] of the compared addresses match. This means that the hit signal will be generated if bits [48:14] match in the respective addresses but the hit signal does not depend on bits [13:12]. Similarly, when the page size is 64 KB then flags 224, 226 are set to 1 to ensure that the outputs of OR gates 222, 228 are always 1, so that comparisons of bits [15:12] do not affect the hit result. Hence, this allows the TLB to be looked up across multiple page sizes.

FIG. 7 similarly shows an example of the alias detection logic 202 for detecting whether a physical address 230 of a new entry to be allocated to the L1 TLB 32 matches the physical address 232 of any existing entry within the TLB. Again, this comparison can be repeated for each entry of the L1 TLB 32. By asserting various flags 234 when the page size is 16 KB or 64 KB, the comparisons of the lower bits [15:14] and/or [13:12] can be masked depending on the page size, to ensure that the alias is only detected if the pages represented by the new and existing entries overlap. Unlike in FIG. 6, it is not only the existing physical address 232 that may be partially masked depending on the page size, but also the physical address 230 associated with the new entry for which the alias is to be detected.

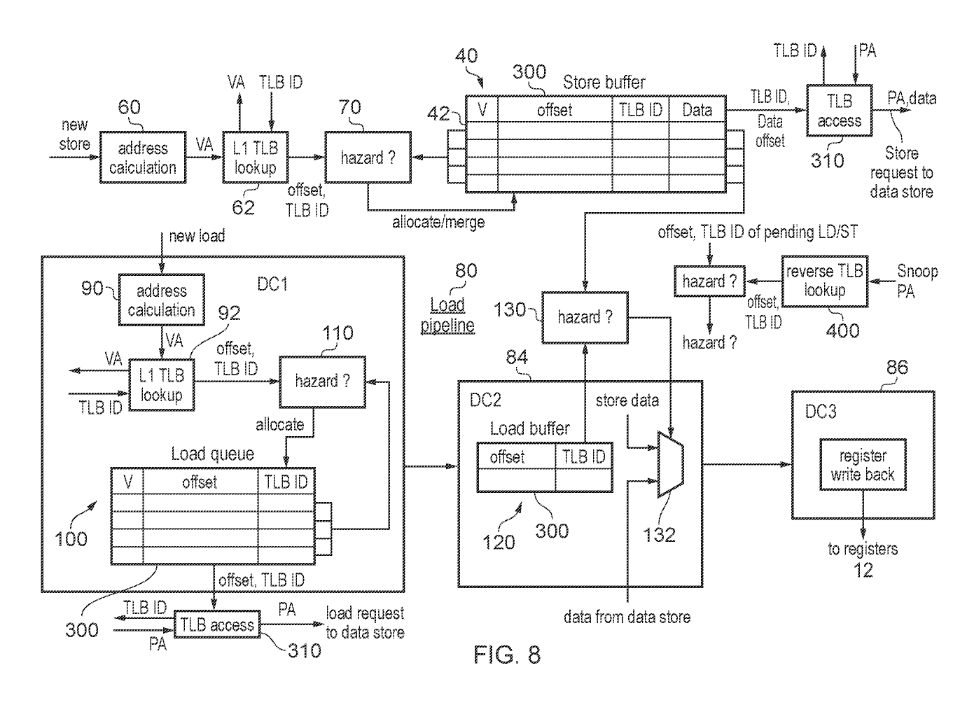

In the example of FIG. 2, each transaction queue stores the full physical address 46, 106 for each pending transaction. However, as shown in FIG. 8 it is also possible to provide an implementation which avoids storing the full physical address anywhere within the load/store unit 20. The circuitry shown in FIG. 8 is generally the same as that of FIG. 2 and so unless otherwise specified it functions in the same way as FIG. 2. Unlike in FIG. 2, when the TLB 30 is looked up at stage 62 of the store pipeline or stage 92 of the load pipeline, rather than returning the full physical address the TLB 30 only returns the TLB ID and then the address offset of the new store or load instruction is provided together with TLB ID to the hazard checking circuitry 70, 110 for hazard checking. Instead of storing the full physical address 46, only the offset portion 300 is stored in the transaction queues 40, 100, 120. The hazard checking circuitry 70, 110, 130 can function in the same way as FIG. 2 since it simply compares the offsets and TLB IDs of respective transactions. However, in this embodiment the storage circuitry required in each transaction queue 40, 100, 120 can be made more efficient since it requires fewer bits for each transaction slot to store the offset instead of the full physical address. However, in this case then when a store or load request is issued to the data store, then an additional TLB access stage 310 is provided to index into the entry of the L1 TLB 32 specified by the TLB ID of the transaction, and when the TLB 30 then returns the required physical address this is combined with the address offset for the transaction to form the physical address which is sent to the data store. Hence, there may be an additional small delay in handling the store or load request, but this approach makes the transaction queues more efficient in terms of circuit area and power consumption.

With the approach shown in FIG. 8, there may be some physically addressed transactions which may need to be hazarded against transactions within one or more of the transaction queues 40, 100, 120. For example, in a multi processor system, another processor within the system may have its own cache which may cache data from a common memory also accessed by the caches of the data store 22. In this case to maintain coherency between the different cached versions of the data, coherency mechanisms may be provided which may for example include one processor sending a snoop transaction to another to determine whether data from a given physical address is cached within the cache of the other processor. The processor receiving the snoop may need to identify whether there are any pending loads or stores to that address and so may perform hazarding of the snoop transaction against each pending load and store. Since the snoop transaction is physically addressed, in the embodiment of FIG. 8 where the load or store buffers or queues do not contain the physical address, then an additional reverse TLB look up stage 400 is provided to search through each entry of the L1 TLB to check whether the physical address specified by the snoop is present, and when one of these TLB entries matches the page address portion of the snoop physical address, then the corresponding TLB ID is returned and this together with the offset can be hazarded against the TLB ID and offset of pending loads and stores to determine whether there is a hazard between the snoop and the load or store. If the L1 TLB 32 does not contain an entry for the physical address of the snoop, it can be determined that there is no hazard without any comparison with the contents of the transaction queues 40, 100, 120, because if there was a pending transaction corresponding to the snooped physical address then the mechanism describes with respect to FIG. 4 would have locked down the corresponding TLB entry to ensure there is an entry with the snooped physical address in the L1 TLB 32. This technique of performing a reverse TLB lookup can be performed for any physically addressed transaction which needs to be hazarded against one of the transactions stored in the transactions queues 40, 100, 120 (not just snoop transactions).

In contrast, in the embodiment of FIG. 2 hazarding of snoop transactions or other physically addressed transactions would be simpler since the physical address can simply be compared against the physical address stored in the transaction queues 40, 100, 120 for pending loads or stores.

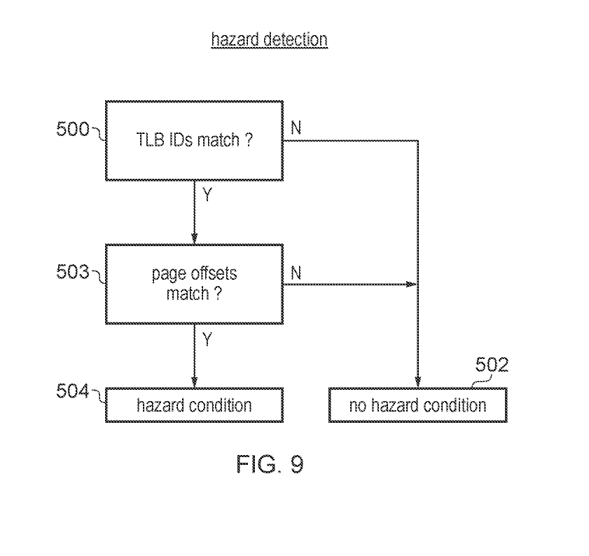

FIG. 9 shows a flow diagram illustrating a method of detecting hazards between a pair of transactions. At step 500 it is determined whether the TLB identifiers identifying the corresponding L1 TLB entries for the pair of transactions match. As mentioned above this would generally be the case if the TLB IDs of the respective transactions are the same, although in the case where aliasing is allowed within the TLB then TLB IDs may also be considered to match if they correspond to an aliased pair of TLB entries which map to the same physical address. If there is no match between the TLB IDs then at step 502 no hazard condition is detected. On the other hand, if the TLB IDs match then at step 503 the page offsets of the respective addresses corresponding to the two transactions are compared, and if there is match then at step 504 a hazard condition is detected while if the page offsets do not match then at step 502 no hazard condition is detected.

While FIG. 9 shows the method as a sequential series of steps, it will be appreciated that some steps could be performed in a different order or in parallel with other steps. For example, the comparisons of the TLB IDs and the offsets could be performed in the opposite order to the order shown in FIG. 9, or in parallel.

While the example of FIG. 2 above shows a particular embodiment in which hazard checking is performed for transactions at certain points of the load/store unit 20, more generally the method of FIG. 9 may be applied to any system using virtual-to-physical address translation where it is required to determine whether a pair of data access transactions correspond to the same physical address.

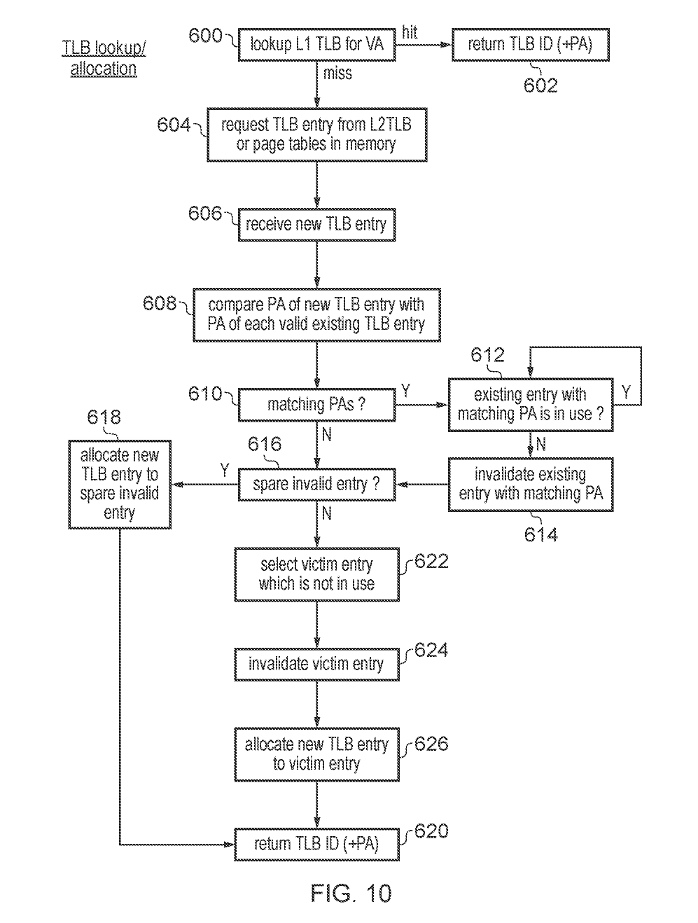

FIG. 10 shows a flow diagram illustrating a method for managing lookups and allocations of entries to the TLB. At step 600, the virtual address (or at least the page address portion of the virtual address) for a new load or store transaction is provided to the TLB which performs a lookup to identify whether any of its entries matches the virtual address. If there is match then the virtual address hits in the L1 TLB and at step the 602 the TLB ID identifying the matching TLB entry is returned to the load store unit. Optionally, the physical address (or at least the physical page address portion of the physical address) is returned as well, although as shown in FIG. 8 this is not essential.

On the other hand, if there is a miss in the L1 TLB 32 then at step 604 the required TLB entry for the specified virtual address is requested from the L2 TLB or from page tables in memory 28 depending on whether the L2 TLB 34 already includes the required entry. A page table walk to memory is performed if necessary and this may be relatively slow if several levels of page table need to be traversed to find the required entry. Eventually, the new TLB entry is received at step 606. At step 608 the alias detection logic 202 compares the physical address of the new TLB entry with a physical address of each valid existing TLB entry in the L1 TLB 32. At step 610 the alias detection circuitry determines whether the compared physical addresses match. If so, the valid existing TLB entry with the matching physical address need to be invalidated.

At step 612 the alias detection logic or the victim selection logic determines whether the existing entry which has the matching physical address is currently in use depending on the information 180 provided from the various transaction queues in the load store unit. If the existing entry to be invalidated is currently in use because there is an in-flight transaction corresponding to it, then the entry cannot be invalidated yet and the method remains at step 612 until that transaction is no longer pending and the transaction queue no longer indicates the entry as in use. At this point then at step 614 the existing entry with the matching physical address is invalidated and then the method proceeds to step 616. Or on the other hand, if at step 610 no matching physical addresses were detected for the new TLB entry then steps 612 and 614 can be omitted. At step 616 it is determined whether there is a spare invalid entry in the L1 TLB 32. If so then at step 618 the new TLB entry received from the L2 TLB 34 or memory is allocated into the spare invalid entry and at step 620 the TLB ID of that allocated entry is returned, and optionally the physical address may also be returned as discussed above.

On the other hand, if at step 616 it is determined that there are no spare invalid entries to accommodate the new TLB entry, then at step 622 the victim selection logic 200 selects a victim entry which is not indicated as in use by the in use mask 180 received from the transaction queue 4, 100, 120. The victim entry could be selected using any known algorithm such as round robin or random, as long as the victim selection policy excludes any in use entries for which there are corresponding transactions in flight. At step 624 the selected victim entry is invalidated and at step 626 the new TLB entry is then allocated to the selected victim entry and at step 620 the TLB ID is then returned.

In this way, allocations to the TLB can be managed to ensure that when hazard checking circuitry detects a matching pair of TLB IDs then this implies that the corresponding physical addresses also match, while when two TLB IDs are different then this implies that the corresponding physical addresses are different.

In the present application, the words “configured to . . . ” are used to mean that an element of an apparatus has a configuration able to carry out the defined operation. In this context, a “configuration” means an arrangement or manner of interconnection of hardware or software. For example, the apparatus may have dedicated hardware which provides the defined operation, or a processor or other processing device may be programmed to perform the function. “Configured to” does not imply that the apparatus element needs to be changed in any way in order to provide the defined operation.

Although illustrative embodiments of the invention have been described in detail herein with reference to the accompanying drawings, it is to be understood that the invention is not limited to those precise embodiments, and that various changes and modifications can be effected therein by one skilled in the art without departing from the scope and spirit of the invention as defined by the appended claims.

We claim:

1. An apparatus comprising:
a translation lookaside buffer (TLB) comprising a plurality of TLB entries to store address translation data for translating a virtual address specified by a data access transaction to a physical address identifying a corresponding location in a data store; and
hazard checking circuitry to detect a hazard condition when two data access transactions correspond to the same physical address;
wherein the hazard checking circuitry comprises a TLB entry identifier comparator to compare TLB entry identifiers identifying the TLB entries corresponding to said two data access transactions; and
the hazard checking circuitry is configured to detect said hazard condition in dependence on whether the TLB entry identifier comparator detects that said TLB entry identifiers match.

2. The apparatus according to claim 1, wherein the physical address comprises a page offset portion mapped directly from a corresponding portion of the virtual address;
the hazard checking circuitry comprises a page offset comparator to compare the page offset portions for said two data access transactions; and
wherein the hazard checking circuitry is configured to detect said hazard condition when the TLB entry comparator detects that said TLB entry identifiers match and the page offset comparator detects that said page offset portions match.

3. The apparatus according to claim 1, comprising at least one transaction queue comprising a plurality of transaction slots for tracking pending data access transactions;
wherein for each pending data access transaction, the corresponding transaction slot identifies the TLB entry identifier of the TLB entry corresponding to that pending data access transaction.

4. The apparatus according to claim 3, wherein in response to receipt of another data access transaction:
the TLB is configured to perform a lookup to identify a target TLB entry corresponding to said other data access transaction; and
the hazard checking circuitry is configured to detect the hazard condition in dependence on whether the TLB entry identifier of the target TLB entry matches the TLB entry identifiers of any of said plurality of transaction slots of said at least one transaction queue.

5. The apparatus according to claim 3, wherein the physical address comprises a physical page address portion translated from a virtual page address portion of the virtual address by the TLB and a page offset portion mapped directly from a corresponding portion of the virtual address; and
for each pending data access transaction, the corresponding transaction slot identifies the page offset portion of the physical address for that data access transaction.

6. The apparatus according to claim 5, wherein for each pending data access transaction, the corresponding transaction slot also identifies the physical page address portion of the physical address for the corresponding data access transaction.

7. The apparatus according to claim 5, wherein for each pending data access transaction, the page offset portion is the only part of the physical address identified by the corresponding transaction slot; and
on issuing the data access transaction for a given transaction slot to the data store, the TLB is configured to access the TLB entry identified by the TLB entry identifier stored in said given transaction slot to identify the physical page address portion of the physical address.

8. The apparatus according to claim 7, wherein in response to a physically addressed transaction specifying a target physical address, the TLB is configured to perform a reverse lookup to identify whether the TLB includes a matching TLB entry for the target physical address, and the hazard checking circuitry is configured to determine whether the hazard condition arises for the physically addressed transaction in dependence on a comparison of the TLB entry identifier of said matching TLB entry with the TLB entry identifiers of the plurality of transaction slots.

9. The apparatus according to claim 8, wherein said physically addressed transaction comprises a snoop transaction for maintaining coherency between the data store and a further data store.

10. The apparatus according to claim 1, wherein the TLB is configured to prevent invalidation or reallocation of a given TLB entry corresponding to a given data access transaction until said given data access transaction has progressed beyond a stage where the given data access transaction is checked for the hazard condition by the hazard checking circuitry.

11. The apparatus according to claim 3, wherein said at least one transaction queue is configured to provide the TLB with an indication of at least one in-use TLB entry whose TLB entry identifier is identified by one of said transaction slots; and
the TLB is configured to prevent invalidation or reallocation of said at least one in-use TLB entry indicated by the at least one transaction queue.

12. The apparatus according to claim 11, wherein following a TLB flush event triggering invalidation of all of said plurality of TLB entries, the TLB is configured to defer invalidation of said at least one in-use TLB entry until that TLB entry is no longer indicated as an in-use TLB entry by the transaction queue.

13. The apparatus according to claim 1, comprising alias detection circuitry to detect an alias condition when a physical address corresponding to a new TLB entry to be allocated to the TLB matches a physical address corresponding to an existing TLB entry of the TLB.

14. The apparatus according to claim 13, wherein in response to detecting the alias condition, the alias detection circuitry is configured to trigger the TLB to invalidate the existing TLB entry.

15. The apparatus according to claim 14, comprising a processing pipeline supporting out-of-order processing of instructions;
wherein in response to detecting the alias condition, the alias detection circuitry is configured to trigger flushing of at least one instruction requiring said existing TLB entry from the processing pipeline when said at least one instruction is dependent on an instruction requiring said new TLB entry.

16. The apparatus according to claim 13, wherein in response to detecting the alias condition, the alias detection circuitry is configured to set alias identification information identifying said new TLB entry and said existing TLB entry as a pair of aliasing TLB entries; and
the TLB entry identifier comparator is configured to detect that the TLB entry identifiers of said two data access transactions match when the TLB entry identifiers correspond to said pair of aliasing TLB entries.

17. The apparatus according to claim 13, wherein the TLB supports TLB entries corresponding to different page sizes; and
the alias detection circuitry is configured to select which portions of the physical addresses corresponding to said existing TLB entry and said new TLB entry to compare in dependence on page size indications identifying the page sizes corresponding to said existing TLB entry and said new TLB entry.

18. An apparatus comprising:
means for storing a plurality of entries to store address translation data for translating a virtual address specified by a data access transaction to a physical address identifying a corresponding location in a data store; and
means for detecting a hazard condition when two data access transactions correspond to the same physical address;
wherein the means for detecting comprises means for comparing entry identifiers identifying the entries corresponding to said two data access transactions; and
the means for detecting is configured to detect said hazard condition in dependence on whether the means for comparing detects that said entry identifiers match.

19. A data processing method comprising steps of:
translating a virtual address specified by a data access transaction to a physical address identifying a corresponding location in a data store using a translation lookaside buffer (TLB) comprising a plurality of TLB entries for storing address translation data; and
detecting a hazard condition when two data access transactions correspond to the same physical address;
wherein the detecting step comprises comparing TLB entry identifiers identifying the TLB entries corresponding to said two data access transactions, and detecting said hazard condition in dependence on whether said TLB entry identifiers match.
